(19) United States
(12) Patent Application Publication
(10) Pub. No.: US 2025/0304440 A1
(43) Pub. Date: Oct. 2, 2025

(54) METHODS FOR CONTROLLING SYNGAS COMPOSITION

(71) Applicants: Bradley D. Damstedt, Williamsville, NY (US); Lawrence E. Bool, III, East Aurora, NY (US)

(72) Inventors: Bradley D. Damstedt, Williamsville, NY (US); Lawrence E. Bool, III, East Aurora, NY (US)

(21) Appl. No.: 19/236,347

(22) Filed: Jun. 12, 2025

Related U.S. Application Data
(63) Continuation of application No. 17/543,905, filed on Dec. 7, 2021.
(60) Provisional application No. 63/141,046, filed on Jan. 25, 2021.

(51) Int. Cl. C01B 3/36

(52) U.S. Cl. CPC C01B 3/36; C01B 2203/0255; C01B 2203/0877; C01B 2203/1241; C01B 2203/148; C01B 2203/1623; C01B 2203/168

(57) ABSTRACT

Disclosed is methodology for controlling the H2:CO ratio of the product produced in a partial oxidation reactor, by adjusting the properties of the product formed in the partial oxidation.

### RELATED APPLICATIONS

This continuation application claims the benefit of U.S. patent application Ser. No. 17/543,905, filed on Dec. 7, 2021 which claims the benefit of U.S. Provisional Application Ser. No. 63/141,046, filed on Jan. 25, 2021, which is incorporated herein by reference.

### FIELD OF THE INVENTION

The present invention relates to the production of syngas so as to control significant characteristics of the syngas so produced.

### BACKGROUND OF THE INVENTION

Primary gasification is often used in industry to convert a feedstock to a syngas stream containing CO and/or H₂ by partial oxidation. A primary gasifier consists of a vessel, typically refractory lined, where a primary feedstock is mixed with an oxidant stream. Common oxidant streams include steam, CO2, oxygen, or mixtures of these streams. Depending on the source of the oxidant other species may also be included, such as N2 or Ar. The ratio of oxidant to feedstock is controlled such that less oxidant is provided than required to completely combust the feedstock. This condition, termed “fuel rich”, leads to the production of desired species such as CO and H2 by partial oxidation. The resulting crude syngas is typically then purified and sent to a downstream process for use. Examples of downstream processes include methanol production and Fischer-Tropsch (“FT”) processes for liquid fuels production.

In some cases the syngas produced by primary gasification may contain significant amounts of unreacted higher molecular weight hydrocarbons which can be problematic for downstream equipment. One example of problematic hydrocarbons is those commonly denoted as “tars” that condense in downstream equipment potentially causing operational and efficiency issues. These problematic hydrocarbons can be further processed by secondary gasification of the hydrocarbon-containing syngas from a primary gasifier. This configuration is similar to a primary gasifier except that the feedstock to the secondary gasifier includes, at least in part, the crude syngas from the primary gasifier. A secondary gasifier may be used with feedstocks generated from hydrocarbon processing, such as refinery off gas (that is, crude syngas is not necessarily generated from a gasification process).

A gasification process is particularly suited for chemicals manufacturing. H2 and CO are converted to chemicals using a variety of processes, including catalytic or biological reactors. To optimize the efficiency of the chemical generating reactors, syngas from a gasification system is conditioned in any of several ways; a partial list of potential conditioning actions is given below. Each conditioning step increases the operating complexity as well as capital and operating cost of the overall chemical plant, so plants limit the number of conditioning steps to only those required.
remove catalyst poisons, for example HCN, sulfur containing species such as H2S or other contaminants
reduce diluents, for example CO2 and H2O
adjust properties, for example pressure and temperature
adjust chemical composition, for example adding nutrients for biological reactors or adjusting the H2 to CO ratio using a water gas shift reactor (WGS).

Depending on the chemical being produced, different syngas properties are required to maximize efficiency. For example, production of transportation fuels using a Fischer-Tropsch system is most efficient with feeds having H2:CO ratios in the range of 1.95 to 2.05. The native H2:CO ratio of a gasification system may not fall within the range required by the downstream process. For example, the native H2:CO ratio of products formed by partial oxidation (POx) gasifiers using natural gas (“NG”) as a feedstock fall within the range of 1.7 to 1.8. If NG is being converted to syngas using a POx gasifier and the syngas is intended to be used to generate ethanol using FT processing, the H2:CO ratio of this syngas will preliminarily be adjusted upward using a WGS reactor. Because of the many types of gasifiers, feedstocks, chemical conversion processes and chemicals, it is recognized that linking the gasification process to the chemical product generation process will usually require adjustment of the H2:CO ratio.

Adjusting the H2:CO ratio in syngas produced by gasifiers such as POx reactors has previously been accomplished by adding into a reactant stream that is fed into the POx reactor, either H2O in the form of steam for situations where a higher H2:CO ratio is desired or a CO2 rich stream when a reduction in H2:CO ratio is desired. (For example, a source of CO2 may be a CO2 stream obtained by a removal process in the conditioning steps.) This is done primarily in steam methane reformers (SMR) but is also applied to a lesser extent with auto thermal reformers (ATR) or even to a lesser extent with partial oxidation reformers.

The present invention utilizes discoveries that enable the control of the characteristics of the syngas which is produced in the POx reactor, that provide advantages in being able to control the characteristics of the syngas.

### BRIEF SUMMARY OF THE INVENTION

One embodiment of the present invention comprises a method of treating a syngas stream, comprising
(A) producing in a partial oxidation reactor a syngas stream that comprises H2 and CO, and
(B) performing one or both of (B1) and (B2) on the syngas stream as produced in the partial oxidation reactor before subjecting the syngas stream to subsequent processing or reaction:
(B1) reducing the temperature of the syngas stream as produced in the partial oxidation reactor under conditions effective to increase the molar ratio of H2:CO of the syngas stream to a value higher than the molar ratio of H2:CO of the syngas stream as produced in the partial oxidation reactor;
(B2) adding steam to the syngas stream as produced in the partial oxidation reactor thereby increasing the molar ratio of H2:CO of the syngas stream to a value higher than the molar ratio of H2:CO of the syngas stream as produced in the partial oxidation reactor.

Preferably the temperature reduction of (B1) is carried out according to a time temperature history s described herein that lowers the temperature at a sufficiently high rate that the H2:CO ratio is modified as desired and is then maintained at a new modified value.

Preferably the addition of steam is provided in a location near the gasifier exit and/or high temperature ductwork connecting the gasifier to the syngas cooler, and preferably provides at least 1 second (preferably up to 5 seconds) of residence time before entering any downstream syngas cooler.

Another embodiment of the present invention comprises a method of treating a syngas stream, comprising
(A) producing in a partial oxidation reactor a syngas stream that comprises H2 and CO, (B)
   adding carbon dioxide to the syngas stream as produced in the partial oxidation reactor before subjecting the syngas stream to subsequent processing or reaction, and thereby decreasing the molar ratio of H2:CO of the syngas stream to a value less than the molar ratio of H2:CO of the syngas stream as produced in the partial oxidation reactor.

Preferably the addition of carbon dioxide is provided in a location near the gasifier exit and/or high temperature ductwork connecting the gasifier to the syngas cooler, and preferably provides at least 1 second (preferably up to 5 seconds) of residence time before entering any downstream syngas cooler.

### BRIEF DESCRIPTION OF THE FIGURES

FIG. 1 is a flowsheet of a facility that utilizes partial oxidation to produce hydrocarbon product such as fuels from feedstock.

FIG. 2 is a cross-sectional view of a device that can produce a stream of hot oxygen useful in this invention.

FIGS. 3-8 are graphs showing characteristics of the invention.

### DETAILED DESCRIPTION OF THE INVENTION

The present invention is particularly useful in operations that convert hydrocarbon products such as biomass to useful hydrocarbon products such as (but not limited to) liquid fuel. The feedstock produced by the present invention includes products that can be sold and used as-is, as well as products that can be used as reactants to produce other finished useful products that can then be sold and used.

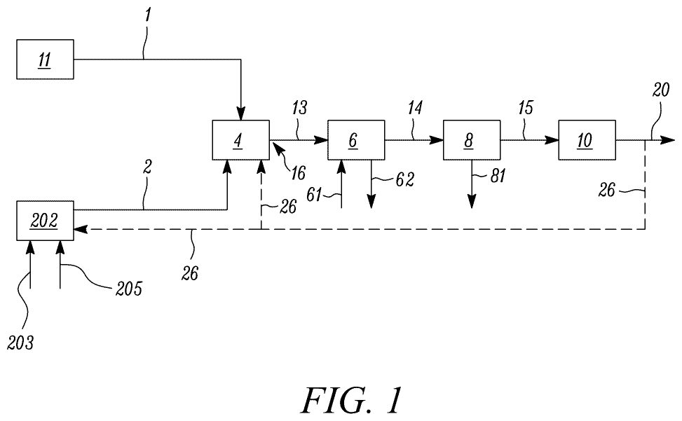

FIG. 1 is a flowsheet that shows the typical steps of such an operation.

Referring to FIG. 1, stream 1 which is also referred to herein as the raw feedstock is fed to partial oxidation reactor 4. Stream 1 is provided from source 11 which designates a production facility or reactor in which raw feed 1 is produced.

Examples of suitable raw feedstocks 1 and their sources 11 include:
Natural gas, from any commercial source thereof;
the gaseous stream that is produced by a gasification reactor, in which solid hydrocarbon material such as biomass or solid fuel such as coal or lignin is gasified in a stream of gas usually comprising air, steam, and/or oxygen at a high enough temperature that at least a portion of the solid material is converted to a gaseous raw stream 1;
product streams and byproduct streams, which more often are gaseous but may be liquid and/or solids, that are produced in a petrochemical refinery or chemical plant;
coke oven gas, being the offgas stream that is produced in a reactor that heat treats coal to produce coke;
pyrolysis gas, being a hydrocarbon-containing gaseous stream that is produced in a reactor to heat treat solid carbonaceous material such as fossil fuel or biomass to devolatilize and partially oxidize the solid material;
Other possible feedstock streams include oils, such as pyrolysis oils, and liquid hydrocarbons.

Raw feedstock 1 generally contains hydrogen and carbon monoxide (CO), and typically also contains one or more hydrocarbons such as alkanes and/or alkanols of 1 to 18 carbon atoms, and often contains one or more of carbon dioxide (CO₂), and higher molecular weight hydrocarbons characterized as tars and/or soot.

The raw feedstock stream 1, if heated as it leaves source 11, typically exhibits a temperature of between about 500° F. and 1600° F.

Raw feedstock stream 1 is then fed into partial oxidation reactor 4 in which it is reacted (under conditions described more fully below) with oxygen that is provided as hot oxygen stream 2 (produced as more fully described below) to produce additional amounts of hydrogen and carbon monoxide (CO) from components present in stream 1. If tars are present in the stream, some or all of tars present can also be converted to lower molecular weight hydrocarbon products.

Oxidized product stream 13 which is produced in partial oxidation reactor 4 is fed to stage 6 in which stream 13 is preferably cooled and treated to remove substances that should not be present when the stream is fed to reactor 10 (described hereinbelow). Stage 6 typically includes a unit which cools stream 13, for instance by indirect heat exchange with incoming feed water 61 to produce stream 62 of heated water and/or steam. In alternative embodiments, stage 6 can also comprise a shift conversion reactor in which carbon monoxide in stream 13 is reacted (in a non-limiting example, with water vapor (steam)) in a catalytically mediated water-gas shift (“WGS”) reaction to produce hydrogen, thereby providing a way to adjust the ratio of hydrogen to carbon monoxide in stream 13. The heat removal in stage 6 and its beneficial advantages are described more fully below. The heat removal in stage 6 is performed before any other treatment or reaction of the syngas.

The resultant stream 14, having been cooled and/or having had its hydrogen:CO ratio adjusted in stage 6, is fed to stage 8 in which impurities 81 that may be present such as particulates, acid gases including CO₂, ammonia, sulfur species, and other inorganic substances such as alkali compounds, are removed. Impurities may be removed in one unit or in a series of units each intended to remove different ones of these impurities that are present or to reduce specific contaminants to the desired low levels. Stage 8 represents the impurities removal whether achieved by one unit or by more than one unit. Cooling and impurities removal are preferably performed in any effective sequence in a series of stages or all in one unit. Details are not shown but will be familiar to those skilled in the art. Stage 8 typically includes operations for final removal of impurities, non-limiting examples of which include particulates, NH₃, sulfur species and CO₂. The CO₂ removal is typically performed by a solvent-based process, which either uses a physical solvent, e.g. methanol, or a chemical solvent, e.g. amine.

The resulting cooled, conditioned gaseous stream 15 is then fed to stage 10 which represents any beneficial use of one or more components present in stream 15. That is, stream 15 can be used as-is as an end product. However, the present invention is particularly useful when stream 15 is to serve as feedstock for further reaction and/or other processing that produces product designated as 20 in FIG. 1.

One preferred example of such further processing is conversion of stream 15 into liquid fuels, such as using stream 15 as feed material to a Fischer-Tropsch process or other synthetic methodology to produce a liquid hydrocarbon or a mixture of liquid hydrocarbons useful as fuel.

Other examples of useful treatment of stream 15 include the production of specific targeted chemical compounds such as ethanol, straight-chain or branched-chain or cyclic alkanes and alkanols containing 4 to 18 carbon atoms, aromatics, and mixtures thereof; or in the production of longer-chain products such as polymers.

The overall composition of stream 15 can vary widely depending on the composition of raw feedstock 1, on intermediate processing steps, and on operating conditions. Stream 15 typically contains (on a dry basis) 20 to 50 vol. % of hydrogen, and 10 to 45 vol. % of carbon monoxide.

However, it is preferred that one or more properties of stream 15 will continually exhibit a value, or a value that falls within a characteristic desired range, in order to accommodate the treatment that stream 15 is to undergo in stage 10 to produce a repeatable, reliable supply of product 20.

In a preferred practice of the present invention, the property of stream 15 that is relevant and that should be maintained within a desired ratio, is the molar ratio of hydrogen (H₂) to CO. For FT fuels production, the target range of H₂:CO molar ratio depends on the product being produced. For example, ethanol production is most efficient with H₂:CO within the range of 1.95 to 2.05. Synthetic gasoline production requires a H₂:CO ratio in the range of 0.55 to 0.65. For fuels production by other conversion mechanisms, such as biological conversion, the target range of H₂:CO molar ratio can be very large. According to the Wood-Ljungdahl pathway, depending on the type of bacteria being used, streams containing only CO, only H₂ or any combination of H₂:CO can be utilized due to the bacteria's ability to convert H₂O and CO₂ into H₂ and CO as needed. Each bacterial strain will prefer a particular chemical makeup of syngas at which it is most efficient in producing the desired product.

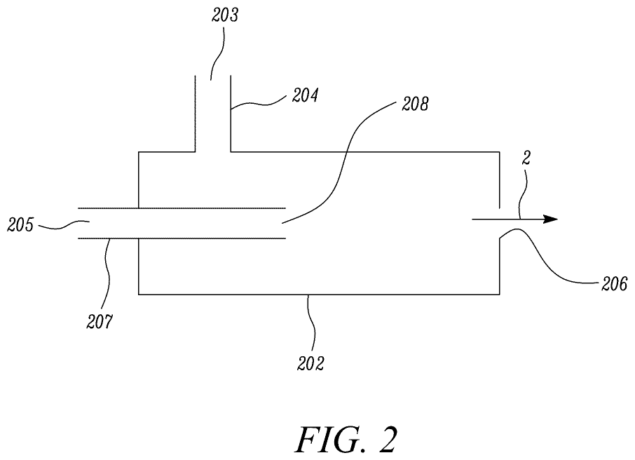

Referring again to FIG. 1, processing in stage 10 may produce byproduct stream 26, which can be recycled to partial oxidation reactor 4 to be used as a reactant, and/or recycled to hot oxygen generator 202 (described below with respect to FIG. 2) to be combusted in hot oxygen generator 202 as described herein. Steam (stream 62) formed from water stream 61 in stage 6 can be optionally fed to partial oxidation reactor 4.

Referring to FIGS. 1-2, hot oxygen stream 2 is fed to partial oxidation reactor 4 to provide oxygen for the desired partial oxidation of raw feedstock 1, and to provide enhanced mixing, accelerated oxidation kinetics, and accelerated kinetics of the reforming with reactor 4.

There are many ways in which the desired high temperature, high velocity oxygen-containing stream can be provided, such as plasma heating.

One preferred way is illustrated in FIG. 2, namely hot oxygen generator 202, that can provide hot oxygen stream 2 at a high velocity. Stream 203 of gaseous oxidant preferably having an oxygen concentration of at least 30 volume percent and more preferably at least 85 volume percent is fed into hot oxygen generator 202 which is preferably a chamber or duct having an inlet 204 for the oxidant 203 and having an outlet nozzle 206 for the stream 2 of hot oxygen. Most preferably the oxidant 203 is technically pure oxygen having an oxygen concentration of at least 99.5 volume percent. The oxidant 203 fed to the hot oxygen generator 202 has an initial velocity which is generally within the range of from 50 to 300 feet per second (fps) and typically will be less than 200 fps.

Stream 205 of fuel is provided into the hot oxygen generator 202 through a suitable fuel conduit 207 ending with nozzle 208 which may be any suitable nozzle generally used for fuel injection. The fuel may be any suitable combustible fluid examples of which include natural gas, methane, propane, hydrogen and coke oven gas, or may be a process stream such as stream 26 obtained from stage 10. Preferably the fuel 205 is a gaseous fuel. Liquid fuels such as number 2 fuel oil or byproduct stream 23 may also be used.

The fuel in stream 205 and the oxidant stream 203 should be fed into generator 202 at rates relative to each other such that the amount of oxygen in oxidant stream 203 constitutes a sufficient amount of oxygen for the intended use of the hot oxygen stream. The fuel 205 provided into the hot oxygen generator 202 combusts therein with oxygen from oxidant stream 203 to produce heat and combustion reaction products which may also include carbon monoxide.

The combustion within generator 202 generally raises the temperature of remaining oxygen within generator 202 by at least about 500° F., and preferably by at least about 1000° F. The hot oxygen obtained in this way is passed from the hot oxygen generator 202 as stream 2 into partial oxidation reactor 4 through and out of a suitable opening or nozzle 206 as a high velocity hot oxygen stream having a temperature of at least 2000° F. up to 4700° F. Generally the velocity of the hot oxygen stream 2 as it passes out of nozzle 206 will be within the range of from 500 to 4500 feet per second (fps), and will typically exceed the velocity of stream 203 by at least 300 fps. The momentums of the hot oxygen stream and of the feedstock, should be sufficiently high to achieve desired levels of mixing of the oxygen and the feed. The momentum flux ratio of the hot oxygen stream to the feedstock stream should be at least 3.0.

The composition of the hot oxygen stream depends on the conditions under which the stream is generated, but preferably it contains at least 50 vol. % O₂ and more preferably at least 65 vol. % O₂. The formation of the high velocity hot oxygen stream can be carried out in accordance with the description in U.S. Pat. No. 5,266,024.

It will be recognized that the desired state of systems that employ partial oxidation in the course of producing hydrocarbon feedstock is this: that there is little or no perturbation of the characteristics of the raw feedstock 1, of the oxygen stream 2, or of streams 13, 14 and 15, nor of the operating conditions employed in the partial oxidation reactor 4 and in stages 6 and 8. In addition, circumstances may arise in which characteristics of raw feedstock 1 to the POx reactor change in a way such that, if nothing else changes in the operating conditions, the characteristics of stream 13 or 15 would be changed in a manner that would adversely affect the characteristics of the desired product stream 20. Such a change in stream 20 is, of course, undesirable.

Alternatively, it will also be recognized that the characteristics of the product to be formed in stage 20 are required to change, necessitating a change on the H2:CO ratio of the syngas at 13.

The characteristics of raw feedstock 1 that could change include the total hydrocarbon concentration of the raw feedstock; the total concentration of C₂H₂, C₂H₄, and tars; and the temperature. Examples of circumstances that could cause any of these characteristics to change include:

The composition of raw feedstock 1 has changed because the feed to source 11 has changed.

The raw feedstock 1 from its source 11 has become too expensive relative to other compositions, from other sources, that could be useful feedstock material to the POx reactor 4.

The treatment provided in one or more of the stages 6 and 8 has changed, such as changes to the catalytic processing that is provided in the WGS reaction.

The injector system that feeds material into the POx reactor has been damaged or fouled so that the ability of the feedstock to be entrained into the hot oxygen stream is lessened, thereby leading to excessive methane slip, excessive tar slip, and/or excessive soot formation.

In the past, customary practice to accommodate changes in circumstances such as these, which involve changes to characteristics of the raw feedstock 1 to POx reactor 4 or changes to the desired product of 20, has often been shutting down the overall facility, or at best running the facility at a partial load which is detrimental to capital recovery. When that occurs, an operator who has more than one such facility must then rely on the output of product that is available from other facilities, or else suffer the loss of production.

It has been found however that the present invention enables the operator to adjust the H2:CO ratio of the syngas product that emerges from the POx reactor, to compensate for any changes in the overall operation that would require adjustment of the H2:CO ratio of that product.

This invention improves the syngas conditioning capability of a chemical plant by controlling the H2:CO ratio in the syngas stream 13 immediately downstream of the gasifier or POx reactor 4. This ability results in a reduction in size or potentially eliminating a WGS reactor (or reverse WGS if a lower H2:CO ratio is needed). This in turn reduces the amount of catalyst needed for initial charging and for replacement.

In this invention, heat energy is removed from the syngas 13 to reduce temperature to a level acceptable for downstream conditioning operations. Removing energy changes the equilibrium composition of the mixture, specifically impacting the relative amounts of H2, H2O, CO and CO2 according to the water gas shift reaction CO+H2O<=>H2+CO2. The difference between the actual concentration of each component and the equilibrium concentration represents a chemical driving force, moving the system toward equilibrium over time.

The rate at which temperature of the stream is lowered impacts the composition of the syngas. At higher temperatures, the syngas retains sufficient energy to overcome kinetic limitations allowing the reaction in the syngas to proceed long enough to produce meaningful change in the composition. Once a syngas is below a certain temperature, even though the driving force for increasing the H2:CO ratio still exists, there is insufficient energy in the gas to promote the reactions, so that the H2:CO ratio of the syngas is “frozen” or “quenched”.

As an alternate embodiment of this invention, stream 16 of steam or CO2 is added to stream 13 near the exit of the POx reactor 4. The temperature of stream 13 is sufficient to enable reactions changing the H2:CO ratio to proceed significantly in reasonable residence times within which the temperature is lowered, potentially in as little as 1 second but preferably within up to 5 seconds, with the temperature having been lowered by the end of this period of time to a temperature at which the H2:CO ratio no longer changes. By modulating the amount of steam 16 (or CO2 16, in the alternative embodiment described elsewhere herein) being added to stream 13 it is possible to obtain a targeted value of H2:CO. For example, if the product being produced by the plant is made most efficiently with a H2:CO ratio of 2.0, steam is added in an amount that maintains the H2:CO ratio. If conditions either upstream or downstream of the POx reactor change, for example if the feedstock to the POx reactor changes in composition or temperature, the steam amount can be adjusted to maintain the H2:CO ratio at 2.0 without making any equipment or other process modifications. Another example is if a different product 20 will be made, it is likely the optimum H2:CO ratio will be different. That is, by adjusting the amount of steam 16 added to the stream 13 at the exit of reactor 4, or even changing from steam addition to CO2 addition (or vice versa), the H2:CO ratio can be adjusted in the POx system to match the target composition of the syngas in stream 13.

The injection of H2O or CO2 into stream 13 near the exit of reactor 4 limits the participation of those components to water gas shift chemistry and not the reforming chemistry. This results in a higher overall H2+CO rate and lower feedstock and O2 rates, resulting in higher productivity and lower operating costs. Additionally, the syngas entering the syngas cooler is at a lower temperature which will increase the syngas cooler lifetime.

### EXAMPLES

### Example 1

Increasing H2:CO Ratio from CH4 Derived Syngas Using Controlled Heat Removal

A simulation of a POx reactor was used to generate syngas properties for two syngas streams: pure CH4 as the feedstock and pure CH4 with steam added to the feedstock. The syngas properties are given in Table 1. A third case uses the CH4 derived syngas, but adds the same amount of steam as the CH4/Steam case at the exit of the POx reactor.

TABLE 1
Syngas properties exiting the POx reactor.

| | | Steam added |
|---|---|---|
| | No steam | to feedstock |
| Flowrate, lbmol/hr | 614.5 | 734.1 |
| T, ° F. | 2550 | 2550 |
| CH4, vol % | 0.8% | 0.1% |
| H2, vol % | 56.5% | 46.1% |
| CO, vol % | 31.4% | 23.2% |
| CO2, vol % | 1.6% | 4.0% |
| H2O, vol % | 9.7% | 26.5% |

To illustrate the effect that heat removal has on the H2:CO ratio of the syngas produced from the POx reactor, equilibrium calculations were performed. A certain amount of heat was removed and the mixture allowed to adjust in temperature and composition according to equilibrium. The equilibrium driving force for H2:CO ratio is shown in FIG. 1. As heat is removed the difference between the initial H2:CO ratio (at 0 MMBTU/hr heat removed) and the equilibrium value grows. This difference represents the potential amount by which the H2:CO ratio can change if given an infinite amount of residence time.

As noted above, the ability of the mixture to actually proceed to an equilibrium state depends on the amount of time it is allowed to react and the temperature of the system. To illustrate the principle of maximizing the H2:CO ratio of the syngas product by controlling the time temperature history of a syngas cooling system and adding steam to the POx reactor exit, a series of detailed kinetic simulations were performed. The same syngas properties as used above for the equilibrium example were used as the input of a reactor network approximating a plug flow reactor with a fixed geometry and constant pressure. GRI 3.0 was used as the reaction mechanism. The total amount of heat loss was set to obtain a syngas final temperature near 400° F. Within each case the total heat removal was kept constant and different heat removal profiles were used to illustrate the effect of the time temperature history on the H2:CO ratio of the syngas product.

FIG. 2 shows a plot of temperature vs H2:CO ratio at four different heat removal profiles from the No Steam case. The heat removal rate was applied uniformly and evenly across the reactor network and is given as a percentage of the total heat removed. A clear trend is observed, showing a higher H2:CO ratio is obtained by removing heat at a slower rate. This is because the lower heat removal rates keep the temperature of the mixture higher for longer and at higher temperatures the mixture reacts more quickly, allowing it to approach closer to equilibrium. Another important point that can be observed from FIG. 2 is the “freezing” temperature. Each of the four curves shown follows a similar pattern: as the mixture is cooled, its H2:CO ratio increases at a constant rate. Once the mixture reaches approximately 1900° F., the rate of increase of the H2:CO ratio begins slowing. Finally at approximately 1500° F. the H2:CO ratio is flat and no longer changes.

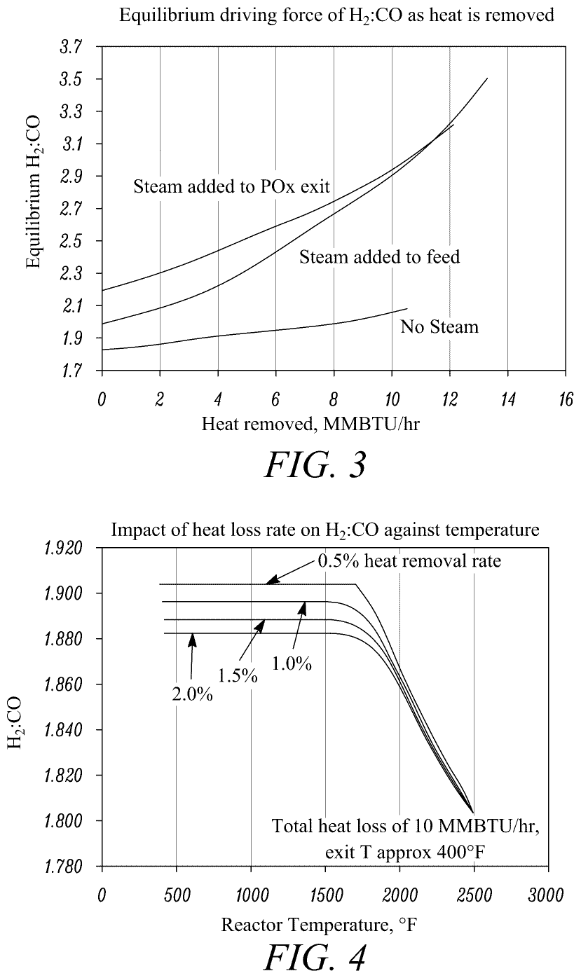

FIG. 3 shows H2:CO ratio as a function of residence time for three simulations. The curve for “0.5% heat removal rate” is for a simulation using a low heat removal rate and shows a slow rise over a long residence time. The solid curve for “2.0%” is for a simulation using a high heat removal rate, showing a rapid rise that quickly “freezes”, resulting in a H2:CO ratio that is lower than the ratio provided by the more gradual heat removal. The dashed curve uses a combination approach, namely a high heat removal rate until the mixture reaches 1900° F., after which the cooling rate is reduced to a low value. The yellow curve shows relatively high H2:CO ratios can be obtained in reasonable residence times.

FIG. 4 shows the residence time requirements to achieve 1900° F. and 1500° F. for each of the three cases. For each case, several heat removal profiles have been included, similar to the data shown in FIG. 3. The trends in FIG. 4 show for each of the three cases that an H2:CO ratio approaching the maximum value achieved at very slow heat removal limit can be achieved in reasonable residence times using the approach of starting with a high heat removal rate and following with a lower rate once the onset of “freezing” (i.e. 1900° F.) occurs.

### Example 2

Increasing H2:CO Ratio from CH4 Derived Syngas Using Steam Addition and Controlled Heat Removal

Looking at the curve in FIG. 4 representing cases deriving from a CH4 syngas with steam removal at the exit of reactor 4 (triangles) shows that a large rise in H2:CO (from 1.79 to higher than 2.2) can be achieved in very short residence times, with the advantages over the CH4/steam syngas described above. Applying both steam injection at the POx reactor exit and a controlled heat removal profile will enable an operator to tune the H2:CO ratio as needed.

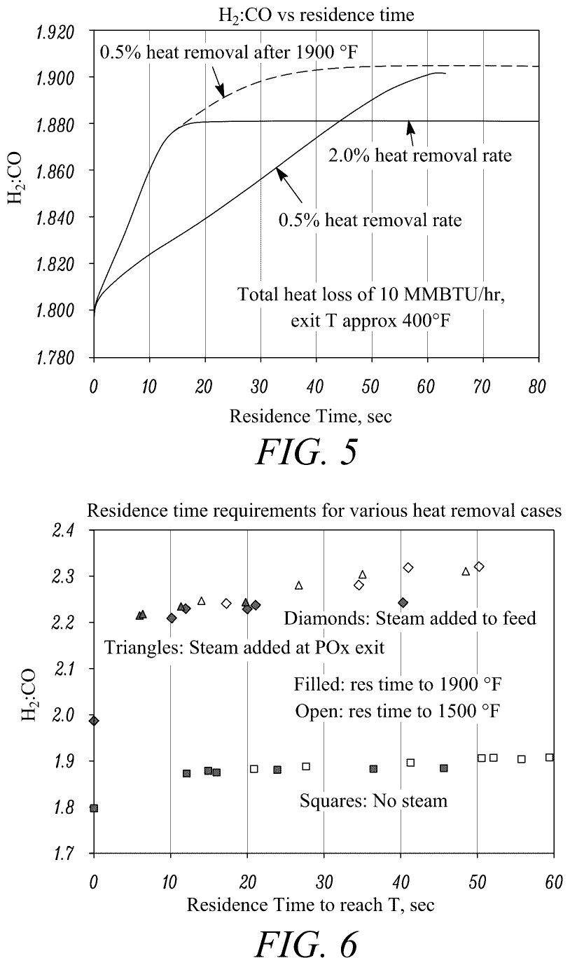

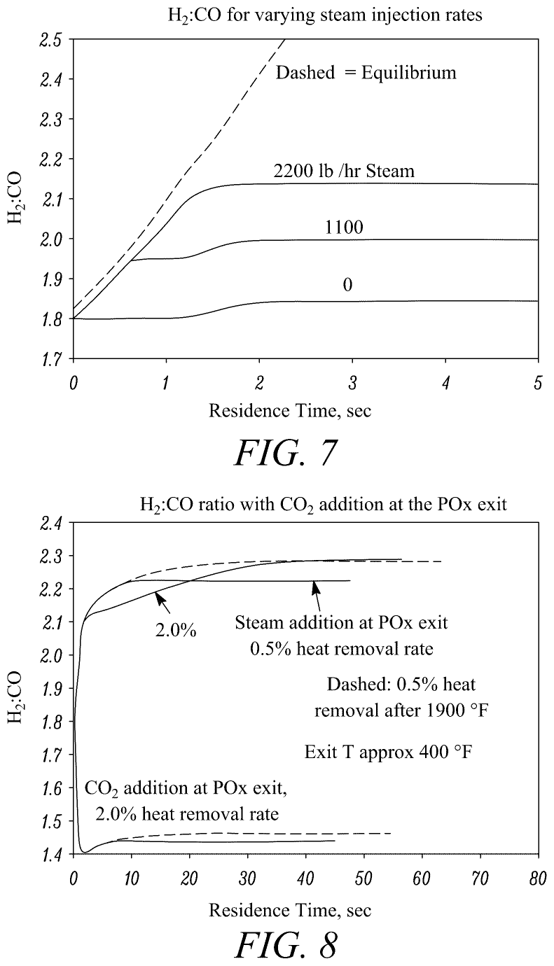

FIG. 5 shows predictions for three simulations. Each simulation utilizes the same syngas (CH4 derived), the same amount of residence time available for steam injection and the same heat removal profile following the steam injection. However, different amounts of steam are added near the exit of the POx reactor. The bottom curve gives results for no steam, the middle curve for a moderate amount of steam, and the topmost curve for a large amount of steam. Modulating the steam rate while maintaining all other parameters shows that it is possible to achieve any H2:CO ratio between 1.84 and 2.14.

This example also shows that the controlled heat removal may not be necessary if steam addition at the POx reactor exit is being used. If a large heat removal immediately follows steam addition at the POx reactor exit and immediately “freezes” the H2:CO ratio of the mixture to a value that cannot be changed further, steam addition at different rates may be sufficient to reach the desired H2:CO ratio. Using a controlled heat removal rate is preferred because it minimizes the amount of steam necessary for a particular H2:CO ratio.

### Example 3

### Decreasing H2:CO Using CO2 Addition

Just as adding steam to the syngas at the POx reactor outlet can increase the H2:CO ratio, adding CO2 to the syngas 13 at the POx reactor outlet will decrease the H2:CO ratio of the syngas 13. FIG. 6 compares CO2 addition to steam addition. The lowermost curves are results from a simulation utilizing CO2 addition at the POx reactor outlet rather than steam addition. A sharp decrease in the H2:CO ratio is initially observed. As heat is removed, the H2:CO ratio increases. As shown in the examples above describing ways of increasing the H2:CO ratio, different heat removal rates will impact the amount of increase of the H2:CO ratio. In this example, because a reduction in H2:CO is desired, rapidly removing all the heat to reach the “freezing” temperature is preferred to prevent the increase in H2:CO caused by gradual heat removal.

The present invention provides numerous advantages in addition to those mentioned above. Staging the injection of H2O or CO2 near the exit of the reactor means that the H2) or CO2 participate in reactions involved in the water gas shift chemistry and not in the reactions of the reforming chemistry. This results in a higher overall H2+CO formation rate is higher and lower feedstock and O2 rates, resulting in higher productivity and lower operating costs. Additionally, the syngas entering the syngas cooler is at a lower temperature which will increase the syngas cooler lifetime.

Adjusting the H2:CO ratio through controlled heat removal and/or through H2O or CO2 injection will reduce the size of or potentially fully eliminate the need for a separate catalytic water gas shift (WGS) reactor. This reduces capital cost as well as maintenance costs for the catalyst.

Moving H2O or CO2 injection from the inlet of the POx reactor to the POx reactor outlet reduces the amount of feedstock and O2 required, reduces operating costs, and increases the amount of H2+CO formed, thereby increasing productivity.

What is claimed is:

1. A method of treating a syngas stream, comprising
(A) producing in a partial oxidation reactor a syngas stream that comprises H2 and CO,
(B) adding carbon dioxide to the syngas stream as produced in the partial oxidation reactor before subjecting the syngas stream to subsequent processing or reaction, and thereby decreasing the molar ratio of H2:CO of the syngas stream to a value less than the molar ratio of H2:CO of the syngas stream as produced in the partial oxidation reactor.

2. A method according to claim 1 wherein the addition of carbon dioxide in (B) is provided in a location near the gasifier exit and/or high temperature ductwork connecting the gasifier to the syngas cooler, and provides up to 5 seconds of residence time before entering any downstream syngas cooler.

3. A method according to claim 1 wherein unreacted hydrocarbon in said product stream, or products obtained by reaction of said unreacted hydrocarbon recovered from the product stream, is recycled to the reactor in which the partial oxidation is performed.

4. A method according to claim 1 wherein the hydrocarbonaceous feedstock material comprises natural gas.

5. A method according to claim 1 wherein the hydrocarbonaceous feedstock material comprises biomass.

6. A method according to claim 1 wherein the hydrocarbonaceous feedstock material is derived from fossil fuel.

7. A method according to claim 1 wherein the partial oxidation is carried out with a gaseous stream comprising at least 50 vol. % oxygen.

8. A method according to claim 1 wherein the partial oxidation is carried out by feeding oxygen into the reactor at a velocity of 500 to 4500 feet per second.

9. A method according to claim 1 wherein the partial oxidation is carried out by feeding oxygen into the reactor at a temperature of at least 2000° F.
